(19) United States
(12) Patent Application Publication
(10) Pub. No.: US 2009/0057632 A1
(43) Pub. Date: Mar. 5, 2009

(54) Mechanical adjustment device of a pressing and guiding sheave assembly of an aerial rope of a mechanical lift installation

(75) Inventors: Laurent Bonifat, La Buisse (FR); Thierry Triolier, Voiron (FR)

Correspondence Address: OLIFF & BERRIDGE, PLC, P.O. BOX 320850, ALEXANDRIA, VA, 22320-4850, US

(73) Assignee: POMAGALSKI SA., FONTAINE (FR)

(21) Appl. No.: 12/216,978

(22) Filed: Jul. 14, 2008

(30) Foreign Application Priority Data
Aug. 27, 2007 (FR) 07 06020

(51) Int. Cl. B66D 3/04

(52) U.S. Cl. 254/390

(57) ABSTRACT

A mechanical adjustment device of a sheave assembly of a mechanical lift installation, where the sheave assembly is equipped with rotary sheaves mounted rotating on a support frame comprising a shoe fixed by clamping means to a support of a pylon of the installation, comprises adjustment means of the incline, obtained after clamping, of the support with respect to the shoe in a lateral direction oriented in a direction parallel to the axes of rotation of the sheaves.

### BACKGROUND OF THE INVENTION

The invention relates to a mechanical adjustment device of a pressing and guiding sheave assembly of an aerial rope of a mechanical lift installation, said sheave assembly being equipped with roller sheaves for guiding the rope, mounted rotating on a support frame along parallel axes of rotation staggered along the support frame in a longitudinal direction of the sheave assembly parallel to the direction of the rope, said support frame comprising a shoe fixed by clamping means to a support of a pylon of the installation in a position where a top surface of the shoe is facing a bottom surface of the support.

### STATE OF THE ART

In mechanical lift installations of the chair-lift or gondola car type for example, the aerial rope is guided and secured to each pylon by a bottom sheave assembly with roller sheaves for supporting and guiding the rope when the latter runs on the line and/or by a top sheave assembly with compression and guiding roller sheaves. A mixed sheave assembly comprises both a bottom sheave assembly and a top sheave assembly. These different combinations of sheave assemblies constitute different variants of rope pressing and guiding sheave assemblies. The invention relates to adjustment of such sheave assemblies, whatever the variant.

The pylons are located between the loading and unloading terminals of the installation. Chairs and/or cars are fixed to the rope by means of fixed or detachable grips. The roller sheaves of the sheave assembly are generally associated in pairs and are fitted on the ends of primary beams articulated in their middle part on the ends of secondary beams, themselves fitted in the same way on tertiary beams, and so on depending on the number of sheaves. The last beam is mounted articulated in its middle part on a shoe fixed to a support of the pylon. The assembly formed by the elemental (primary, secondary, tertiary etc . . . ) beams and the shoe forms a support frame of the sheave assembly. In this way, the sheaves of the sheave assembly are mounted rotating on the support frame along parallel axes of rotation staggered along the support frame in a longitudinal direction of the sheave assembly which is substantially parallel to the direction of the rope.

Whatever the variant of the embodiment of the sheave assembly, the lack of incline of the sheaves with respect to a vertical plane is a determining factor in terms of maintenance and safety of the sheave assembly and more generally of the whole installation. A sheave assembly in which the sheaves present an incline does in fact cause premature wear of the rope, of all the sheaves of the sheave assembly, in particular at the level of the bands, and of the detachable vehicle grips. Such a defect can also have the consequence of making the vehicles suspended near the sheaves lose their horizontality.

For a sheave assembly fixed to a support, such a defect appears automatically when the support is not horizontal (horizontality considered in the widthwise direction of the line and not in the direction of the rope). Indeed, when the support is inclined in the widthwise direction of the line, the shoe of the sheave assembly fixed to this support automatically presents an incline of the same value and in the same direction. As the support frame is completely rigid in the widthwise direction of the line, this results in this case in the sheaves being inclined at an angle of the same value with respect to a vertical plane.

When performing adjustment of a sheave assembly, the only known method to attempt to compensate an incline of the sheaves due to a corresponding incline of the support involves using a shim in the form of a wedge fitted between the shoe and the support before the shoe is clamped against support. The wedge is a totally rigid part. The angle at the apex of this wedge has to be exactly equal to the value of the angle of incline of the support. If this is not the case, an incline of the sheaves equal to the angular defect of the wedge persists in spite of the presence of the wedge. As the precision required is difficult to respect both during measurement of the defects and during manufacture of the wedge, the quality of the result obtained is random. Moreover, each inclined support requires manufacture of a specific wedge. This results in very high manufacturing costs which lead to a financial loss.

### OBJECT OF THE INVENTION

The object of the invention consists in providing a device for mechanical adjustment of a pressing and guiding sheave assembly of an aerial rope of a mechanical lift installation whereby adjustment can be made dependable while at the same time reducing the associated costs.

The device according to the invention is remarkable in that it comprises means for adjusting the incline, obtained after clamping, of the support with respect to the shoe in a lateral direction oriented parallel to the axes of rotation of the sheaves.

Unlike the wedge used in the prior art which does not allow any adjustment of the final incline of the support in the lateral direction with respect to the shoe after clamping (since, by using a wedge, said incline is directly equal to the fixed value of the angle at the apex of said wedge), such adjustment means enable the incline the support presents, after clamping, with respect to the shoe (or vice-versa) to be adjusted in situ until the sheaves of the sheave assembly are rendered perfectly vertical. In other words, adequate handling of the adjustment means ensures that after adjustment of the sheave assembly (and after the shoe has been clamped against the support), the sheaves of the sheave assembly no longer present any verticality defect. The dependability of adjustment of the sheave assembly is therefore enhanced. The very function of these adjustment means, i.e. to perform adjustment of the lateral incline the support presents with respect to the shoe (or vice-versa) after clamping, enables the adjustment means to be identical for all the supports where such an adjustment is necessary. Such an advantage makes standardized manufacture of the adjustment means possible. This results in reduced manufacturing costs.

According to a preferred embodiment, the adjustment means comprise a first spacer of fixed height inserted between a first zone of the top surface of the shoe and the bottom surface of the support and a second spacer of variable height inserted between the bottom surface of the support and a second zone of the top surface of the shoe, the second zone being offset with respect to the first zone in the lateral direction. Adjustment of the final lateral incline after clamping is achieved very simply by adjusting the length of the second spacer.

Other technical features can be used either alone or in combination:
the second spacer comprises a stack, in a transverse direction of the sheave assembly perpendicular to the top surface of the shoe, of a first and second bevelled wedges with cooperating reversed lateral ramps, the first and second wedges being respectively mobile and fixed in the lateral direction,
it comprises a threaded element arranged in the lateral direction and mounted in the first wedge in the form of a spiral connection and in the second wedge in the form of a mixed connection with a pivot and slide of transverse direction,
the adjustment means comprise an adjustable lateral safety stop performing lateral blocking of the first wedge on the opposite side from the second wedge,
the second spacer is mounted rotating on the top surface of the shoe with an articulation axis perpendicular to the lateral direction,
the first spacer is mounted rotating on the bottom surface of the support with an articulation axis perpendicular to the lateral direction.

### BRIEF DESCRIPTION OF THE DRAWINGS

Other advantages and features will become more clearly apparent from the following description of a particular embodiment of the invention given for non-restrictive example purposes only and represented in the accompanying drawings, in which:

FIGS. 1 and 2 represent a first example of an adjustment device according to the invention, respectively in lateral cross-section along the cross-sectional line A-A of FIG. 2, and in a side view,

FIG. 3 illustrates detail B of FIG. 1,

FIG. 4 illustrates the device of the previous figures along the cross-sectional line D-D of FIG. 3,

FIG. 5 represents the detail C of FIG. 1,

FIGS. 6 and 7 illustrate a second example of an adjustment device according to the invention in side view respectively for the opposite maximum values of the incline in the lateral direction.

### DESCRIPTION OF A PREFERRED EMBODIMENT OF THE INVENTION

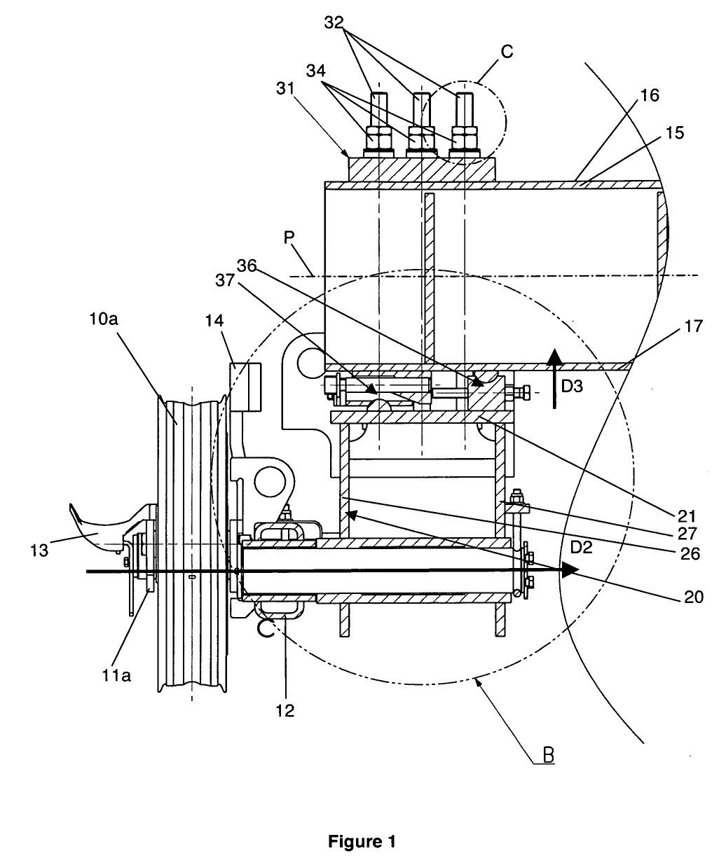

FIGS. 1 and 2 illustrate two roller sheaves 10a, 10b of a pressing and guiding sheave assembly of an aerial rope of a mechanical lift installation. Roller sheave 10a is mounted rotating freely on one end of a first primary beam 11a, whereas second sheave 10b is mounted rotating freely on one end of a second primary beam 11b aligned with first primary beam 11a. Sheaves 10a, 10b are therefore mounted rotating on primary beams 11a, 11b of the sheave assembly with parallel axes of rotation staggered in a longitudinal direction D1 (see arrow in FIG. 2) of the sheave assembly which is parallel to the direction of the rope. The end of first primary beam 11a bearing first sheave 10a is longitudinally facing the end of second primary beam 11b bearing sheave 10b. Sheaves 10a, 10b are thereby longitudinally adjacent, although being mounted on different primary beams 11a, 11b. Each primary beam 11a, 11b is articulated, in the middle part thereof, on the end of a secondary beam 12.

The axes of rotation of sheaves 10a, 10b on primary beams 11a, 11b, and the axes of articulation of primary beams 11a, 11b on secondary beam 12, are all parallel to one another in a lateral direction D2 of the sheave assembly (see arrow in FIG. 1). The lateral direction D2 is therefore oriented in a direction parallel to the axes of rotation of sheaves 10a, 10b. In the lateral direction D2, primary beams 11a, 11b are arranged on one side of sheaves 10a, 10b whereas secondary beam 12 is placed on the other side. The side comprising primary beams 11a, 11b corresponds to the outside of the sheave assembly and the side comprising secondary beam 12 corresponds to the inside of the sheave assembly.

The sheave assembly is equipped, on the outside, with several rope catchers 13 in case of derailment of the rope, and on the inside with several anti-derailment stops 14. A rope catcher 13 and anti-derailment stop 14 are associated with a pair of sheaves mounted on a primary beam 11a, 11b.

The sheave assembly is fixed to the top of a pylon of the mechanical lift installation, more precisely to the end of a tubular support 15 of square cross-section the main axis P whereof is substantially horizontal support 15 comprises a top surface 16 and a bottom surface 17 joined to one another by means of two side surfaces 18, 19.

To fix the latter to support 15, the sheave assembly comprises a shoe 20, on the inside, fitted between secondary beam 12 and support 15. Shoe 20 comprises a U-shaped foot having a flat base 21 and two lateral wings 22, 23. Base 21 comprises a top surface 24 and bottom surface 25. Two laterally offset longitudinal flange plates 26, 27 extend perpendicularly from bottom surface 25 in two planes parallel to one another and perpendicular to lateral direction D2. Lateral wings 22, 23 extend perpendicularly from top surface 24 in two planes parallel to one another and perpendicular to longitudinal flange plates 26, 27.

Secondary beam 12 is mounted pivoting on shoe 20 in the central part of the beam. This fitting is performed by means of a swivel arm 28, parallel to the lateral direction D2 of the sheave assembly, joining the two longitudinal flange plates 26, 27 and securedly affixed to the latter. Each flange plate 26, 27 comprises a pass-through hole, in its part opposite from base 21, for one end of swivel arm 28 to pass through. Articulation of secondary beam 12 on one of the ends of swivel arm 28 can be achieved by any suitable means. Fixing of swivel arm 28 to shoe 20 is performed at the opposite end of swivel arm 28, for example by means of a U-bolt 29 securedly affixed to longitudinal flange plate 27 and able to perform radial clamping of swivel arm 28. According to a possible embodiment, U-bolt 29 comprises a U-shaped clamping element the branches whereof are threaded at the ends. Each of the threads operates in conjunction with a securing nut 30. Swivel arm 28 passes through U-shaped clamping element the branches whereof pass through flange plate 27 via holes arranged in a horizontal plate of flange plate 27. Each securing nut 30 is screwed onto the part of a branch of the clamping element that is salient from the pass-through holes of flange plate 27.

This results in shoe 20 and secondary beam 12 being mounted swivelling freely with respect to one another. The relative orientation of secondary beam 12 with respect to shoe 20 is thereby variable in a plane perpendicular to lateral direction D2. Whatever the relative orientation, flange plates 26, 27 remain perpendicular to lateral direction D2 and parallel to D1, whereas base 21 and lateral wings 22, 23 remain parallel to D2. The angle formed by longitudinal direction D1 (which is associated with secondary beam 12) with respect to base 21 and to lateral wings 22, 23 is on the other hand variable.

The assembly formed by the elemental (primary 11a, 11b and secondary 12) beams and by shoe 20 forms the support frame of the sheave assembly. In the same way as sheaves 10a, 10b, all of the sheaves (of variable number according to the number of elemental beams) of the sheave assembly are mounted rotating on the support frame with parallel axes of rotation staggered along the support frame in the longitudinal direction D1 of the sheave assembly.

Shoe 20 is fixed to support 15 by clamping means, after the foot has been positioned under support 15 in a position where top surface 24 of base 21 is facing bottom surface 17 of support 15 and where each lateral wing 22, 23 is facing a side surface 18, 19 of support 15. This position of lateral wings 22, 23 on each side of support 15 in the longitudinal direction D1 prevents shoe 20 from rotating with respect to support 15 around an axis parallel to the lateral direction D2. The gap between a lateral wing 22, 23 and the corresponding side surface 18, 19 is adjusted by means of an adjustment screw 35 mounted spirally on lateral wing 22, 23, the end of which screw is pressing on side surface 18, 19.

The clamping means comprise a cramp formed by a clamping plate 31 added onto top surface 16 of support 15 and by clamping screws 32 connecting clamping plate 31 and base 21 of shoe 20. Three clamping screws 32 are arranged on each side of support 15 parallel to side surfaces 18, 19. The bottom end of each clamping screw 32 passes through base 21 and its top end passes through clamping plate 31. The bottom end is provided with a support head 33 whereas a nut 34 is added via the top end of each clamping screw 32. Base 21 and clamping plate 31 are inserted between support head 33 and nut 34. Tightening of nuts 34 moves clamping plate 31 towards base 21 of shoe 20. As clamping plate 31 is resting on support 15, this results in a corresponding movement of shoe 20 towards support 15. The clamping means therefore perform an adjustable and reversible relative movement of top surface 24 of base 21 of shoe 20 towards bottom surface 17 of support 15. Adjustment and reversibility are obtained by adjusting nuts 34.

The pressing and guiding sheave assembly partially represented in the figures is a sheave assembly of bottom type: the two main sheaves 10a, 10b represented are therefore roller sheaves for supporting and guiding the rope. The remainder of the description could indifferently be adapted to a pressing and guiding sheave assembly of the top type which would be equipped with roller sheaves for compression and guiding of the rope.

As a consequence of imprecise construction of the pylon, main axis P of support 15 may present a horizontality defect. This defect results in the bottom surface 17 of support 15 not being a horizontal plane and presenting a first incline in the longitudinal direction D1 and/or a second incline in the lateral direction D2. In the case of the first incline, projection of the vector normal to bottom surface 17 onto a horizontal plane comprises a first component along a first horizontal axis corresponding to the vertical projection of D1 on said plane. In like manner, the second incline means that projection of the vector normal to bottom surface 17 onto a horizontal plane comprises a second component along a second horizontal axis corresponding to the vertical projection of D2 on said plane.

The role of the mechanical adjustment device according to the invention is to compensate the second incline in the lateral direction D2, but not the first incline, so as to ensure that, after adjustment, top surface 24 of base 21 of shoe 20 does not present any incline in the lateral direction D2 after clamping, in spite of an incline of bottom surface 17 of support 15 in the lateral direction D2. Thus, after adjustment and whatever the incline of support 15 in the lateral direction D2, projection of the vector normal to top surface 24 onto a horizontal plane does not comprise any component along the horizontal axis corresponding to the vertical projection of D2 onto said plane.

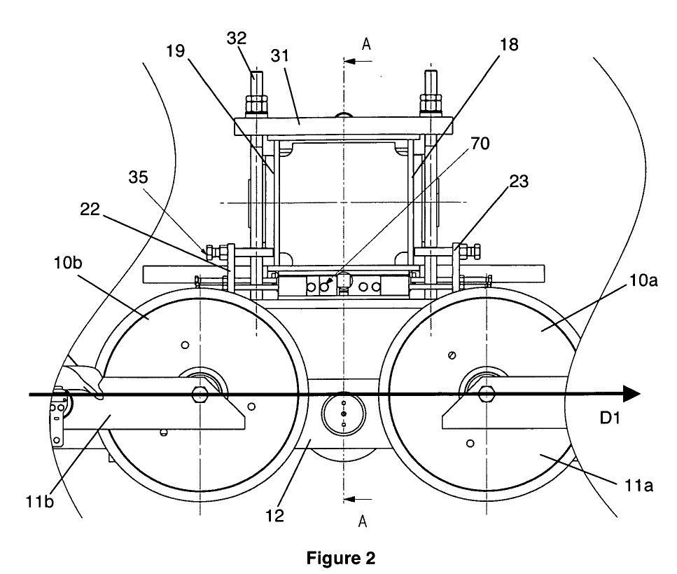

To achieve this, and according to the invention, the mechanical adjustment device comprises means for adjusting the incline, obtained after clamping, of support 15 with respect to shoe 20 in the lateral direction D2. The device is for example fitted between top surface 24 of shoe 20 and bottom surface 17 of support 15 before clamping is performed between support 15 and shoe 20. In FIGS. 1 to 5, a first example of an adjustment device according to the invention is represented. Such an adjustment device can be built-in when the sheave assembly is constructed or can be added onto any existing shoe 20.

With reference to the figures, the adjustment means comprise first and second spacers 36, 37 inserted between top surface 24 of shoe 20 and bottom surface 17 of support 15. First spacer 36, of fixed height, is inserted between a first zone of top surface 24 of shoe 20 and bottom surface 17 of support 15. Second spacer 37 is for its part of variable height and is inserted between bottom surface 17 of support 15 and a second zone of top surface 24 of shoe 20. The second zone is offset with respect to the first zone in the lateral direction D2 of the sheave assembly.

The direction perpendicular to top surface 24 of shoe 20 corresponds to a transverse direction D3 of the sheave assembly (see arrow in FIG. 1). The transverse direction D3 is perpendicular to the lateral direction D2. The angle between the longitudinal direction D1 (which is associated with secondary beam 12) and the transverse direction D3 (which is associated with shoe 20) is on the other hand variable by swivelling of secondary beam 12 with respect to shoe 20.

First spacer 11 is formed by a transverse stack of a first strip 38 and a second strip 39, both oriented perpendicularly to the lateral direction D2. First strip 38 is securedly attached to base 21 to be salient from top surface 24. The cross-section of first strip 38 is globally square. First strip 38 comprises a bottom surface 40 welded onto top surface 24 of base 21 and a top surface 41 turned towards bottom surface 17 of support 15. Top surface 41 and bottom surface 40 are joined by two side faces 42, 43 parallel to one another and perpendicular to top surface 24 of base 21. Side surface 42 is turned towards sheaves 10a, 10b and side surface 43 is turned towards the opposite side, i.e. in the direction of the pylon. Top surface 41 comprises a straight receptacle 44 oriented along the main axis of first strip 38. The cross-section of receptacle 44 is an arc of a circle. Second strip 39 comprises a semi-cylindrical cross-section whose radius corresponds to the radius of the arc of a circle of the cross-section of receptacle 44. Second strip 39 therefore comprises a bottom surface 45 in the form of a semi-cylinder resting in receptacle 44 and a flat top surface 46 pressing against bottom surface 17 of support 15.

It is apparent from the above that second strip 39 is free in rotation with respect to first strip 38 along an articulation axis X1 which corresponds to the mid-line of top surface 46 of second strip 39. This rotation is the result of possible sliding of bottom surface 45 of second strip 39 in receptacle 44. First spacer 36 is thus mounted rotating on the bottom surface 17 of support 15 along an articulation axis X1 perpendicular to the lateral direction D2 and to the transverse direction D3.

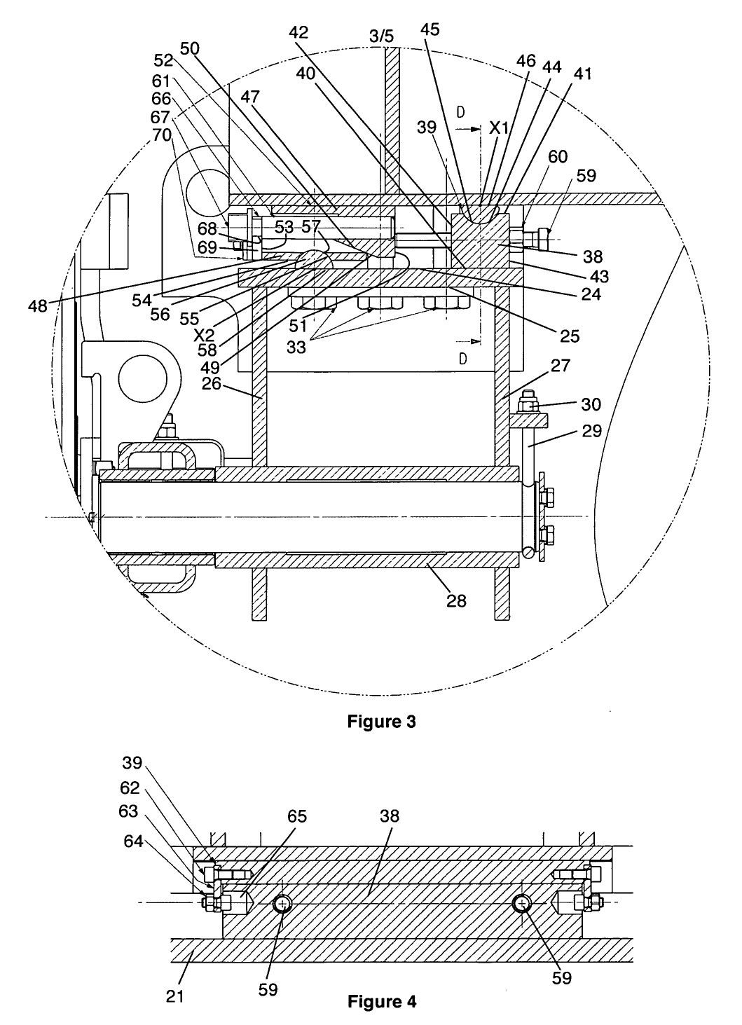

To ensure that second strip 39 can not come out of receptacle 44, each end of second strip 39 is provided with a retaining device (see FIG. 4). Each retaining device comprises a fixing screw 62 screwed into the corresponding end of second strip 39 and performing fixing of one end of a connecting element 63 directed towards base 21. A centering device 64 is fitted perpendicularly to the opposite end of connecting element 63 so as to come and engage in a retaining aperture 65 provided at the corresponding end of first strip 38.

Second spacer 37 comprises a stack of a first and a second bevelled wedges 47, 48 in the transverse direction D3. Each wedge comprises a lateral ramp, respectively referenced 49, 50. Lateral ramp 49 of first wedge 47 is a flat surface having a normal vector directed towards base 21. This normal vector comprises a first component in the lateral direction D2 and a second component in the transverse direction D3. Lateral ramp 50 of second wedge 48 is a flat surface parallel to lateral ramp 49 of first wedge 47. Lateral ramps 49, 50 are inverted and cooperate with one another by relative sliding.

First wedge 47 presents a transverse cross-section in the shape of a right-angled triangle. The hypotenuse corresponds to lateral ramp 49. The small side corresponds to a side face 51 facing first spacer 36. More precisely, side face 51 of first wedge 47 is parallel to side surface 42 of first strip 38. The large side of the right-angled triangle corresponds to a top face 52 of first wedge 47. Top face 52 is pressing against bottom surface 17 of support 15.

Second wedge 48 also presents a transverse cross-section in the shape of a right-angled triangle. The hypotenuse corresponds to lateral ramp 50. The small side corresponds to a side face 53 turned towards sheaves 10a, 10b. The large side of the right-angled triangle corresponds to a bottom face 54 of second wedge 48. Bottom face 54 comprises a straight receptacle 55 oriented parallel to second strip 39. The cross-section of receptacle 55 is an arc of a circle.

The assembly formed by transverse superposition of wedges 47, 48 is fitted, in the transverse direction D3, onto a third strip 56 forming an integral part of second spacer 37. Third strip 56 is parallel to first and second strips 38, 39. Third strip 56 is securedly attached to base 21 to be salient from top surface 24. Third strip 56 comprises a semi-cylindrical cross-section whose radius corresponds to that of the arc of circle of cross-section of receptacle 55 provided in bottom face 54 of second wedge 48. Third strip 56 therefore comprises a top surface 57 in the form of a semi-cylinder coming into receptacle 55 and a flat bottom surface 58 welded onto top surface 24 of base 21.

It is apparent from the above that third strip 56 is free in rotation with respect to second wedge 48 along an articulation axis X2 which corresponds to the mid-line of bottom surface 58 of third strip 56. This rotation is the result of the possible sliding of top surface 57 of third strip 56 in receptacle 55. Second spacer 37, which is composed of wedges 47, 48 and of third strip 56, is thus mounted rotating on top surface 24 of shoe 20 with an articulation axis X2 perpendicular to the lateral direction D2 and to the transverse direction D3.

First spacer 36 of fixed height is therefore inserted between bottom surface 17 of support 15 and a first zone of top surface 24. The first zone is formed by the zone of top surface 24 that is in contact with bottom surface 40 of first strip 38. Second spacer 37 of variable height is for its part inserted between bottom surface 17 of support 15 and a second zone of top surface 24. The second zone is formed by the zone of top surface 24 which is in contact with bottom surface 58 of third strip 56.

Third strip 56 welded to shoe 20 and housed in receptacle 55 has the effect of fixing second wedge 48 in the lateral direction D2. On the other hand, by relative sliding of lateral ramps 49, 50 and top face 52 of first wedge 47 being in flat pressing liaison with bottom surface 17 of support 15, first wedge 47 is mobile in the lateral direction D2. The relative lateral positioning of first and second wedges 47, 48 is adjusted by actuation in rotation of a threaded element 61 arranged in the lateral direction D2 and fitted in first wedge 47 with a spiral connection and in second wedge 48 with a mixed pivot and slide connection of transverse direction D3. The mixed connection with second wedge 48 allows rotation of threaded element 61 around its main axis and translation in the transverse direction D3, independently from one another.

To achieve the mixed connection between threaded element 61 and second wedge 48, a spacer 66 is added against side face 53 of second wedge 48 to fit laterally between a head 67 of threaded element 61 and second wedge 48. Inserted between head 67 and the threaded section in contact with first wedge 47, threaded element 61 comprises a groove 68 the axial length whereof is larger than the thickness of spacer 66. Threaded element 61 passes through spacer 66 in the lateral direction D2, through a transverse slot 69 having parallel edges separated by a distance that is just larger than the diameter of groove 68 to leave a functional clearance. The lateral positioning of threaded element 61 is achieved by head 67 pressing against spacer 66. Groove 68 is therefore laterally positioned in the thickness of spacer 66 and the edges of slot 69 perform holding of threaded element 61 in the direction parallel to strips 38, 39 and 56. Furthermore, head 67 is provided at its base with an annular rim. A stop plate 70 is fitted against the annular rim on the same side as head 67 opposite spacer 66 by screwing into spacer 66. Stop plate 70 performs securing of threaded element 61 in the lateral direction D2. Threaded element 61 remains free in translation in the transverse direction D3 by sliding along transverse slot 69, and in rotation around its main axis.

In addition to first and second spacers 36, 37, the adjustment means according to the invention comprise an adjustable lateral safety stop performing lateral blocking of first wedge 47 on the opposite side from second wedge 48. The lateral stop performs retaining of first wedge 47 in the lateral direction D2 in case of breaking of threaded element 61 or in case of breaking of connection between threaded element 61 and first wedge 47. Lateral stop is formed by the end of at least one screw 59 (two in number in the example represented) passing through first strip 38 in the lateral direction D2 and exiting on the two surside surfaces 42, 43. The end of the part of screw 59 salient from side surface 42 forms lateral stop proper. The body of 59 is fitted with a spiral connection in first strip 38. The part of screw 59 salient from side surface 43 receives an added-on locknut 60.

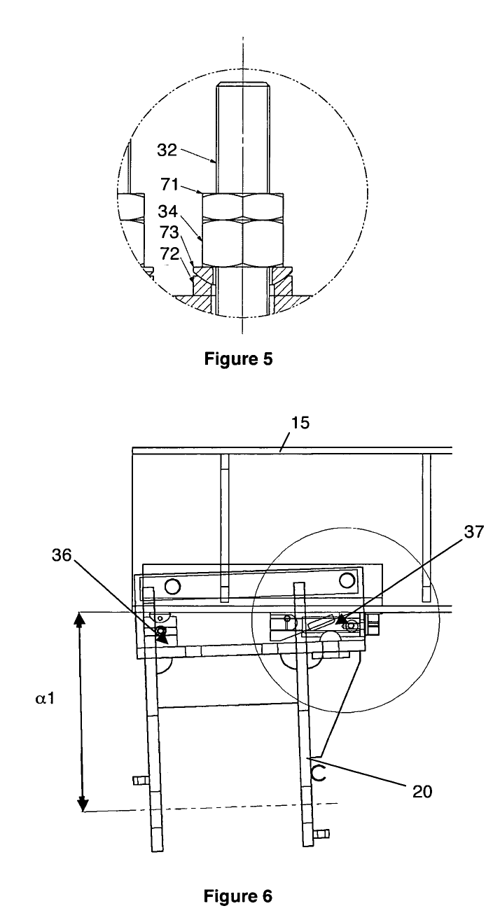

FIG. 5 illustrates that a safety locknut 71 is arranged against nut 34 added on from the top end of each clamping screw 32. The adjustable-direction pressing means of nut 34 on clamping plate 31 are further fitted between nut 34 and clamping plate 31. These adjustable-direction pressing means are formed by a stack of a first washer 72 and a second washer 73. First washer 72 comprises a flat bottom surface coming into flat pressing contact against top surface 16 of support 15, and a top surface in the form of a spherical dish. Second washer 73 for its part comprises a flat top surface coming into flat pressing contact against nut 34, and a bottom surface in the form of a spherical dome having a radius corresponding to the top surface of first washer 72. Second washer 73 is therefore mounted with a ball and socket connection with respect to first washer 72. This connection is the result of the possible sliding of the bottom surface of second washer 73 in the dish formed by the top surface of first washer 72.

After the adjustment device has been implemented, clamping screws 32 are not necessarily perpendicular to support 15. The adjustable-direction pressing means of nut 34 on support 15 automatically ensure, during tightening of nut 34, formation of an angle between the pressing force applied by nut 34 and the compression forces applied by first washer 72 on clamping plate 31 which is equal to the incline of clamping screws 32. This automatic operation ensures that the compression forces applied on support 15 are uniform and perpendicular by compensating the angular variations of clamping screws 32.

The adjustment device described above is used when support 15 presents an incline in the lateral direction D2 as a result of imprecise construction of the pylon. This incline is expressed by the fact that projection of the vector normal to bottom surface 17 onto a horizontal plane comprises a component along a horizontal axis corresponding to the vertical projection of D2 onto said plane. Before nuts 34 are tightened, the two spacers 36, 37 are fitted and the length of second spacer 37 is adjusted. The length adjustment operation corresponds to adjustment proper. Adjustment must be such that the incline of support 15 with respect to shoe 20 in the lateral direction D2, obtained after nuts 34 have been tightened, is equal to the incline in the lateral direction D2 of support 15 with respect to the horizontal. In this way, after nuts 34 have been tightened, projection of the vector normal to top surface 24 onto a horizontal plane does not comprise any component along the horizontal axis corresponding to the vertical projection of D2 onto said plane. By suitable length adjustment of second spacer 37, the operator is ensured that top surface 24 of shoe 20 does not present any incline in the lateral direction D2 after nuts 34 have been tightened. This result is accessible whatever the incline of support 15 in the lateral direction D2. On the other hand it is clear that the length of second spacer 37 is directly dependent on the incline of support 15 in the lateral direction D2. The adjustment device therefore enables the incline of support 15 with respect to shoe 20, obtained after securing, to be adjusted in the lateral direction. It does not however enable the incline of support 15 with respect to shoe 20, obtained after securing, to be adjusted in the longitudinal direction D1.

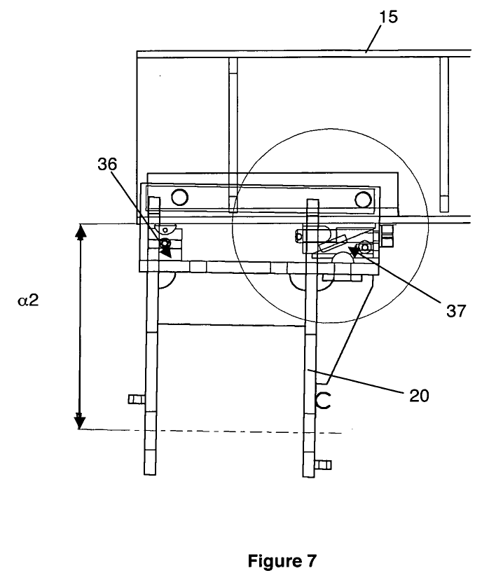

FIGS. 6 and 7 illustrate a second example of an adjustment device according to the invention which differs from the first example by the fact that the lateral positioning of the first and second spacers 36, 37 is reversed. FIGS. 6 and 7 respectively represent the maximum incline α1, α2 in the lateral direction D2 of support 15 with respect to shoe 20 after clamping, corresponding to a minimum length and a maximum length of second spacer 37.

In FIG. 6, second spacer 37 of variable length is adjusted to its minimum length. The minimum length is smaller than the fixed length of first spacer 36. As second spacer 37 is placed, with respect to first spacer 36, on the opposite side from sheaves 10a, 10b, this results in the maximum incline α1, after clamping, of support 15 with respect to shoe 20 in the lateral direction D2 being of negative value. In the example represented, α1 is substantially equal to −2°.

In FIG. 7 on the other hand, second spacer 37 is adjusted to its maximum length. The maximum length is greater than the fixed length of first spacer 36. The maximum incline α2, after clamping, in the lateral direction D2 of support 15 with respect to shoe 20 is therefore of positive value. In the example represented, α2 is substantially equal to +1°.

For the second example of the adjustment device according to the invention, the operator can only adjust the incline, after clamping, in the lateral direction D2 of support 15 with respect to shoe 20, to a value comprised within the range of values the limits of which are α1 and α2.

1. A device for mechanical adjustment of a pressing and guiding sheave assembly of an aerial rope of a mechanical lift installation, said sheave assembly being equipped with roller sheaves for guiding the rope, mounted rotating on a support frame along parallel axes of rotation staggered along the support frame in a longitudinal direction of the sheave assembly parallel to the direction of the rope, said support frame comprising a shoe fixed by clamping means to a support of a pylon of the installation in a position where a top surface of the shoe is facing a bottom surface of the support, comprising adjustment means of the incline, obtained after clamping, of the support with respect to the shoe in a lateral direction oriented in a direction parallel to the axes of rotation of the sheaves.

2. The device according to claim 1, wherein the adjustment means comprise a first spacer of fixed height inserted between a first zone of the top surface of the shoe and the bottom surface of the support and a second spacer of variable height inserted between the bottom surface of the support and a second zone of the top surface of the shoe, the second zone being offset with respect to the first zone in the lateral direction.

3. The device according to claim 2, wherein the second spacer comprises a stack, in a transverse direction of the sheave assembly perpendicular to the top surface of the shoe, of a first and second bevelled wedges with cooperating reversed lateral ramps, the first and second wedges being respectively mobile and fixed in the lateral direction.

4. The device according to claim 3, comprising a threaded element arranged in the lateral direction and mounted in the first wedge in the form of a spiral connection and in the second wedge in the form of a mixed connection with a pivot and slide of transverse direction.

5. The device according to claim 3, wherein the adjustment means comprise an adjustable lateral safety stop performing lateral blocking of the first wedge on the opposite side from the second wedge.

6. The device according to claim 2, wherein the second spacer is mounted rotating on the top surface of the shoe with an articulation axis perpendicular to the lateral direction.

7. The device according to claim 2, wherein the first spacer is mounted rotating on the bottom surface of the support with an articulation axis perpendicular to the lateral direction.
